(19) United States
(12) Patent Application Publication
(10) Pub. No.: US 2018/0225366 A1
(43) Pub. Date: Aug. 9, 2018

(54) AUTOMATICALLY PERFORMING FUNERAL RELATED ACTIONS

(71) Applicant: Inheritance Investing Inc, Columbus, GA (US)

(72) Inventor: Radiah J. Mallard, Columbus, GA (US)

(21) Appl. No.: 15/891,668

(22) Filed: Feb. 8, 2018

Related U.S. Application Data
(60) Provisional application No. 62/457,058, filed on Feb. 9, 2017.

(51) Int. Cl. G06F 17/30; G06Q 50/18; H04L 29/08

(52) U.S. Cl. CPC G06F 17/30702; H04L 67/306; G06Q 50/186

(57) ABSTRACT

For automatically performing funeral related actions, the processor generates a funerary database comprising a plurality of actionable entries for a client. Each actionable entry includes an action condition, a client status description, a client status value, and an action. In response to the client status value satisfying the action condition, the processor automatically performs the action for the actionable entry.

### CROSS-REFERENCE TO RELATED APPLICATIONS

This application claims priority to U.S. Provisional Patent Application No. 62/457,058 entitled “AUTOMATICALLY PERFORMING FUNERAL RELATED ACTIONS” and filed on Feb. 9, 2017 for Radiah Mallard, which is incorporated herein by reference.

### FIELD

The subject matter disclosed herein relates to automatically performing funeral related actions.

### BACKGROUND

### Description of the Related Art

Making and fulfilling end of life arrangements involves significant confidential information.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of an automatic action system;

FIG. 2A is a schematic block diagram illustrating one embodiment of an actionable entry;

FIG. 2B is a schematic block diagram illustrating one embodiment of a client status value;

FIG. 2C is a schematic block diagram illustrating one embodiment of a client entry;

FIG. 2D is a schematic block diagram illustrating one embodiment of a funerary database;

FIG. 2E is a schematic block diagram illustrating one embodiment of a distributed ledger;

FIG. 2F is a schematic block diagram illustrating one embodiment of system data;

FIG. 3A is a drawing illustrating one embodiment of a display of a limited set of actionable entry displays;

FIG. 3B is a drawing illustrating one embodiment of action information;

FIG. 4 is a schematic block diagram illustrating one embodiment of a computer;

FIG. 5A is a schematic flow chart diagram illustrating one embodiment of an automatic action method;

FIG. 5B is a schematic flow chart diagram illustrating one embodiment of an actionable entry display method; and

FIG. 5C is a schematic flow chart diagram illustrating one embodiment of an action performance method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

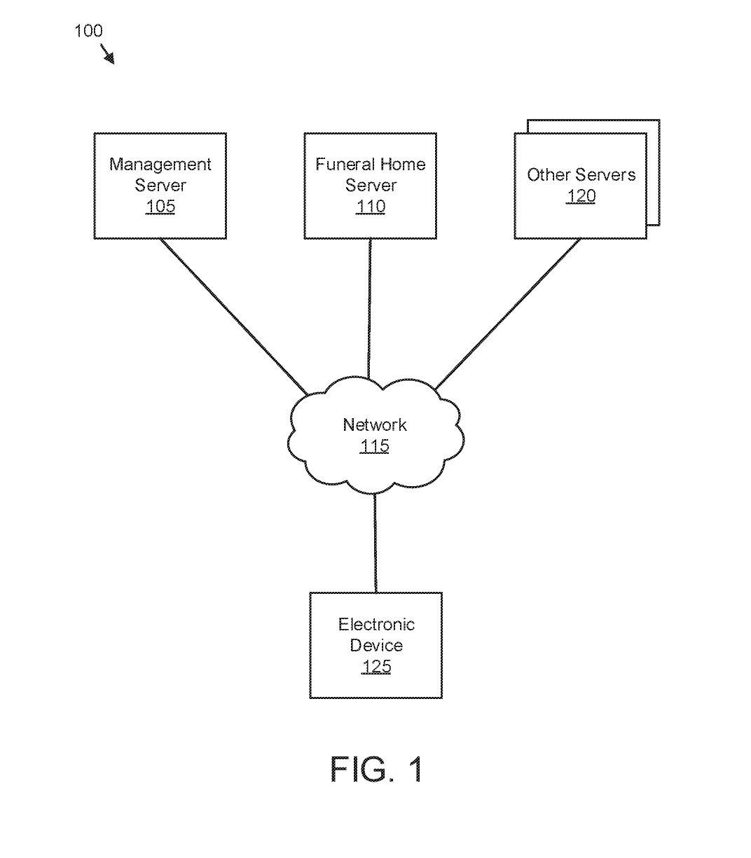

FIG. 1 is a schematic block diagram illustrating one embodiment of an automatic action system 100. The system 100 may automatically perform funeral and/or disability related actions. In the depicted embodiment, the system 100 includes a management server 105, a funeral home server 110, one or more other servers 120, a network 115, and an electronic device 125.

The network 115 may be the Internet, a Wi-Fi network, a mobile telephone network, a wide-area network, a local area network, or combinations thereof. The management server 105, funeral home server 110, other servers 120, electronic device 125 may communicate through the network 115. The electronic device 125 may be a mobile telephone, a tablet computer, a computer workstation, a laptop computer, or the like.

When a person passes away or becomes impaired/incapacitated, many actions should be identified and performed for the benefit of the person and the person's heirs. Unfortunately, the person is often unable to provide critical information in the time leading up to his passing and/or incapacity that is needed to perform these actions. In addition, performing actions including gathering the information and acting on the information require communicating confidential information that must be protected. When a person is incapacitated or deceased, he or his heirs are also vulnerable to fraud.

The embodiments described herein generate a funerary database with actionable entries for a client. The actionable entries are generated while maintaining the confidentiality and security of the client information. Actionable entries may be generated to gather needed information for the funerary database.

In response to determining the client is deceased or impaired, the embodiments automatically perform the actions for each actionable entry. The actions may be performed securely. In addition, the actions may be auditable. As a result, important actions for the client are identified and securely performed, with full accountability.

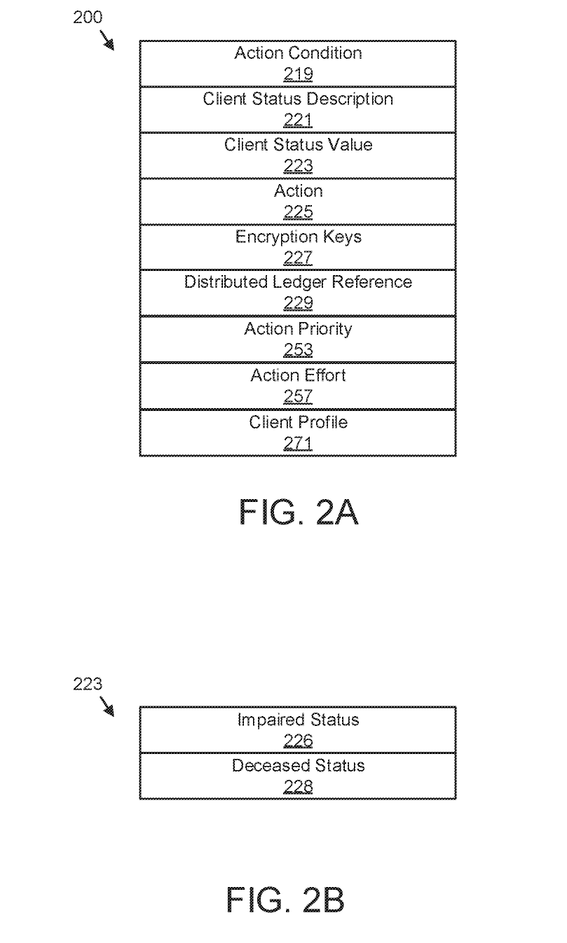

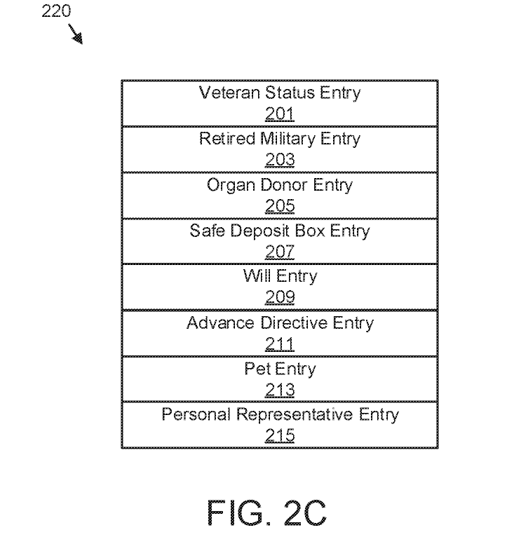

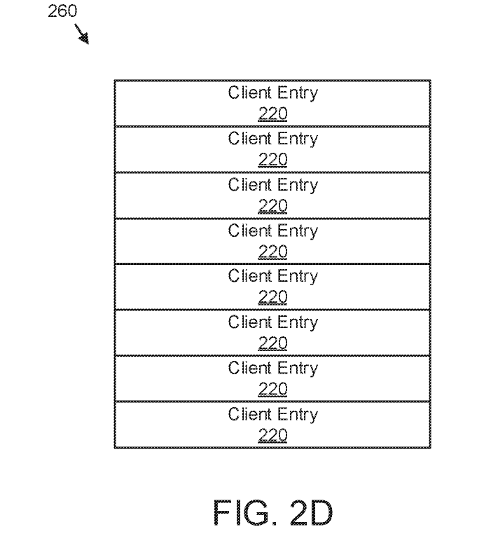

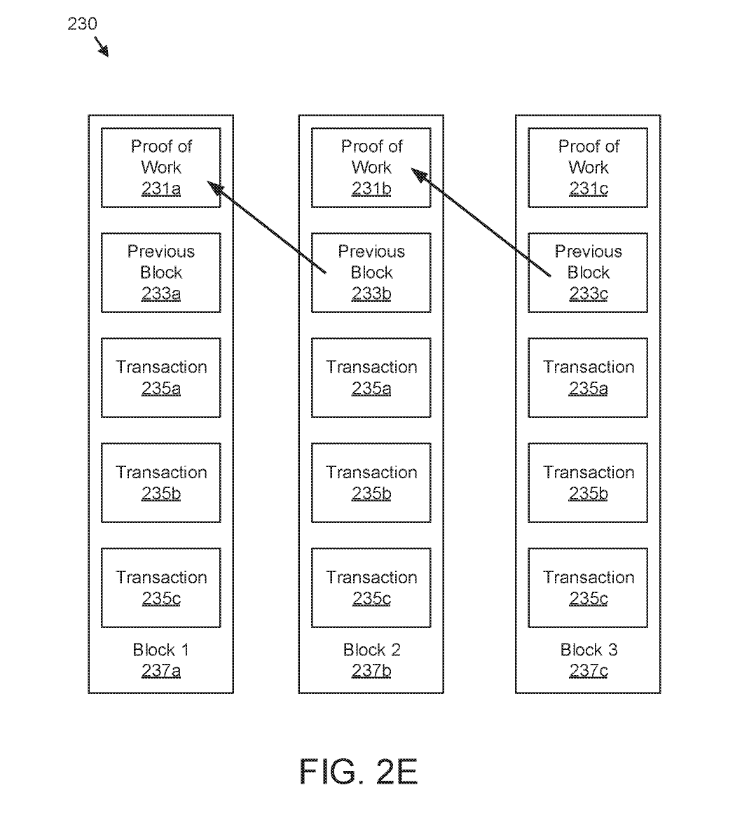

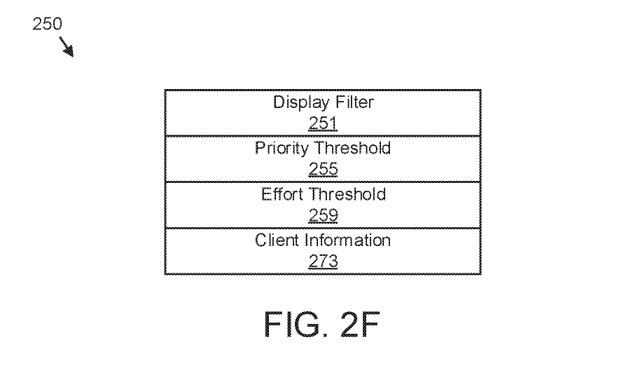

FIG. 2A is a schematic block diagram illustrating one embodiment of an actionable entry 200. The actionable entry 200 may store specific information for a client as well as describe an action 225 that is automatically performed if an action condition 219 is satisfied. The actionable entry 200 may be organized as a database in a memory. In the depicted embodiment, the actionable entry 200 includes the action condition 219, a client status description 221, a client status value 223, the action 225, encryption keys 227, a distributed ledger reference 229, an action priority 253, an action effort 257, and a client profile 271.

The action condition 219 may encode one or more conditions for performing one or more actions 225. In one embodiment, the action condition 219 is encoded as a Boolean expression. In addition, the action condition 219 may be encoded as a natural language condition. The action condition 219 may be satisfied if the Boolean expression and/or natural language condition is satisfied by the client status value 223 of the actionable entry 200 and/or the client status value 223 of another actionable entry 200. In addition, the action condition 219 may be satisfied if the Boolean expression and/or natural language condition is satisfied by the client status description 221 of the actionable entry 200 and/or the client status description 221 of another actionable entry 200.

In one embodiment, the action condition 219 is that the client is one of deceased and impaired. In addition, the action condition 219 may be that needed information for the client that is missing. Table 1 lists action conditions 219 including action conditions 219 for needed information.

The client status description 221 may record status information for the client. The status information may be entered by the client. In addition, the status information may be entered by a guardian and/or personal representative. In one embodiment, the status information in the client status description 221 is generated using information from the client profile 271.

The client profile 271 may describe the client. Information from the client profile 271 may be presented to a user when the user is entering status information. In one embodiment, the client profile 271 is parsed from client information as will be described hereafter.

The client status value 223 may summarize the client status description 221 as actionable values. The action condition 219 may be satisfied based on the client status value 223. The action 225 encodes one or more processes that are automatically performed in response to the action condition 219 being satisfied by the client status value 223. The action 225 may include addresses for sending communications and/or protocols for executing transactions. Table 1 lists exemplary client status values 223 as well as corresponding action conditions 219 and actions 225.

TABLE 1

| client status values 223 | Action condition 219 | Action 225 |
|---|---|---|
| Emergency contact | No emergency contact | Query for emergency |
| | | contact |
| Designated personal | No designated personal | Query for designated |
| representative | representative listed | personal representative |
| Designated personal | No designated personal | Query for designated |
| representative | representative documents | personal representative |
| documents | | documents |
| Pet identified | Pet ownership uncertain | Query for pet ownership |
| Pet information | No pet information for | Query for pet information |
| | identified pets | |
| Safe deposit box | Safe deposit box uncertain | Query for safe deposit |
| | | box |
| Safe deposit box | Safe deposit box | Query for safe deposit |
| information and key | information and key | box and key location |
| location | location not known | |
| A burial contract | Burial contract uncertain | Query for burial contract |
| Burial contract | No burial contract | Query for burial contract |
| information | information | information |
| Burial contract | No burial contract | Query for burial contract |
| documents | documents uploaded | documents |
| Property ownership | Property ownership | Query regarding property |
| | uncertain | ownership |
| Property description | No property description | Query for property |
| and documents | and/or documents | description and |
| | | documents |
| Insurance policies | Insurance policies | Query for insurance |
| | uncertain | policies |
| Insurance policy | No insurance policy | Query for insurance |
| information | information | policy information |
| Insurance policy | No insurance policy | Query for insurance |
| documents | documents | policy documents |
| Bank account | Bank uncertain | Query for bank account |
| Bank account | No bank account | Query for bank account |
| information | information | information |
| Investment account | Investment account | Query for investment |
| | uncertain | account |
| Investment account | No investment account | Query for investment |
| information | information | account information |
| Loan | Loan status uncertain | Query for loan status |
| Loan information | No loan information | Query for loan |
| | | information |
| Credit card | Credit card status uncertain | Query for credit card |
| | | status |
| Credit card | No credit card information | Query for credit card |
| information | | information |
| Recurring bills | Recurring bills uncertain | Query for recurring bills |
| Recurring bill | No recurring bill | Query for recurring bill |
| information | information | information |

The encryption keys 277 may be used to securely exchange information when gathering the client status description 221 and/or client status value 223. In addition, the encryption keys 227 may be used to securely perform the action 225. In one embodiment, the encryption keys 227 are used to perform a distributed ledger transaction. The encryption keys 227 may also include user identifiers and passwords for accessing accounts.

The distributed ledger reference 229 may record one or more distributed ledger transactions. The distributed ledger reference 229 supports the auditing of actions 225 performed using a distributed ledger transaction as will be described hereafter.

The action priority 253 may specify a priority of each action 225 of the action entry 200. In one embodiment, a low, medium, and high priority is assigned as the action priority 253 for each action 225. In addition, a numerical priority may be assigned as the action priority 253 for each action 225.

The action effort 257 may estimate a time interval required to complete each action 225 of the action entry 200. The action effort 257 may indicate one of a short, medium, and long time interval required to complete each action 225. In addition, the action effort 257 may include a numerical estimate of the time interval required to complete each action 225.

FIG. 2B is a schematic block diagram illustrating one embodiment of a client status value 223. In the depicted embodiment, the client status value 223 indicates whether the client has an impaired status 226 that indicates that the client is impaired or a deceased status 228 that indicates that the client is deceased.

FIG. 2C is a schematic block diagram illustrating one embodiment of a client entry 220. The client entry 220 may be for a client. Each client entry 220 includes information related to caring for and/or carrying out the wishes of a client as described in a plurality of actionable entries 200 as described FIG. 2A. In addition, each actionable entry 200/201/203/205/207/209/211/213/215 may include actions 225 for gathering information and/or providing care or carrying out end-of-life wishes.

The client entry 220 may be organized as a data structure in a memory. In the depicted embodiment, the actionable entries 200 include a veteran status entry 201, a retired military entry 203, an organ donor entry 205, a safe deposit box entry 207, a will entry 209, an advanced directive entry 211, a pet entry 213, and a personal representative entry 215.

The veteran status entry 201 may include a client status description 221 that describes the client's military service. The client status description 221 may include documentation of an honorable discharge from military service. A Boolean client status value 223 may indicate the honorable discharge from military service. The action condition 219 may be satisfied if the Boolean client status value 223 is True and the client is deceased status 228. The action 225 may comprise sending a message to a Veterans Administration burial address to request a Veterans Administration burial. Alternatively, the action 225 may comprise transacting a distributed ledger transaction with the Veterans Administration to request a Veterans Administration burial.

In one embodiment, the plurality of actionable entries 200 includes a retired military entry 203 with a client status description 221 that describes the client's military service and a Boolean client status value 223 that indicates the client retired from military service. The client status description 221 may include documents relating to the client's retirement from military service. The action condition 219 may be satisfied if the Boolean client status value 223 is True and the client is deceased status 228. The action 225 may comprise sending a message to a Veterans Administration benefits address to request death benefits. In addition, the action 225 may comprise transacting a distributed ledger transaction with the Veterans Administration to request death benefits.

The plurality of actionable entries 200 may include an organ donor entry 205 with a client status description 221 that records the client's wishes with regards to organ donation and a Boolean client status value 223 that indicates the client is an organ donor. The client status description 221 may further include executed documents for enabling an organ donation. The action condition 219 may be satisfied if the Boolean client status value 223 is True and the client is deceased status 228. The action 225 may comprise sending a message comprising a link to organ donor instructions to one or more of a personal representative address, an organ donation address, and a funeral service provider address. In addition, the action 225 may comprise transacting a distributed ledger transaction with a funeral service provider and/or organ donation service to initiate the organ donation.

Because time is of the essence in organ donations, the embodiments improve the function of the computer in expeditiously arranging for an organ donation. As a result, organs in an organ donation may be harvested while still viable.

In one embodiment, the plurality of actionable entries 200 includes a safe deposit box entry 207 with a client status description 221 and a Boolean client status value 223 that indicates the client has a safe deposit box. The client status description 221 may include safe-deposit box documents and/or the location of the safe-deposit box key. The action condition 219 may be satisfied if the Boolean client status value 223 is True and the client is deceased status 228. The action 225 may comprise sending a message with safe deposit documents and/or the location of the safe-deposit box key to a personal representative address. In one embodiment, the safe-deposit documents and/or location of the safe-deposit box key are communicated using a distributed ledger transaction.

In one embodiment, the plurality of actionable entries 200 includes a will entry 209 with a client status description 221 that may include a will document and a Boolean client status value 223 that indicates the client has a will. The action condition 219 may be satisfied if the Boolean client status value 223 is True and the client is deceased status 228. The action 225 may comprise sending a message comprising the will document to the personal representative address. In addition, the action 225 may comprise a distributed ledger transaction recording the transmission of the will document. The distributed ledger transaction may include a hash of the will document. Alternatively, the distributed ledger transaction may include the will document. As a result, the communication of the will document to the personal representative may be audited in the future, preventing fraud with respect to the will.

In one embodiment, the plurality of actionable entries 200 includes an advance directive entry 211. The client status description 221 for the advanced directive entry 211 may include an advanced directive document. In addition, the client status description 221 may include a statement, audio recording, and/or video recording of the client's wishes regarding the advanced directive. A Boolean client status value 223 may indicate the client has an advance directive. The action condition 219 is satisfied if the Boolean client status value 223 is True and the client having an impaired status 226. The action 225 may comprise sending a message comprising the advance directive document to the personal representative address and a care giver address. In one embodiment, the action includes communicating the advanced directive document via a distributed ledger transaction. As a result, the communication of the advanced directive document and the receipt of the advanced directive document by a personal representative and/or caregiver may be audited.

The plurality of actionable entries 200 may further include a pet entry 213 with a client status description 221 that describes a pet and the care thereof and a Boolean client status value 223 that indicates the client owns and/or cares for a pet. The action condition 219 may be satisfied if the Boolean client status value 223 is True and the client is deceased status 228 or impaired status 226. The action 225 may comprise sending a message with pet care information to a personal representative.

In one embodiment, the plurality of client entries 220 includes a personal representative entry 213 with a client status description 221 and a Boolean client status value 223 that indicates the client has a personal representative. The client status description 221 may include account access information, a power of attorney, a will, and the like. The action condition 219 may be satisfied if the Boolean client status value 223 is True and the client is deceased status 228 or impaired status 226. The action 225 may comprise sending a message comprising a request and the client status description 221 information and documents included therein to the personal representative address. In one embodiment, the designation of the personal representative and the communication of the client status description 221 account access information and documents included therein is communicated via distributed ledger transaction. The client status description 221 and documents may be recorded in the distributed ledger transaction as a hash of the client status description 221 and/or documents. As a result, the designation of the personal representative and the delivery of relevant documents may be audited.

FIG. 2D is a schematic block diagram illustrating one embodiment of a funerary database 260. The funerary database 260 may be maintained by the management server 105 as a data structure in a memory. In the depicted embodiment, the funerary database 260 includes a plurality of client entries 220.

FIG. 2E is a schematic block diagram illustrating one embodiment of a distributed ledger 230. The distributed ledger 230 may be used to perform distributed ledger transactions. The distributed ledger 230 includes multiple blocks 237 for a set of distributed ledger transactions 235. For simplicity, three blocks 237a-c are shown in the depicted embodiment. However, any number of blocks 237 may be employed. Each block 237 may be stored on a server such as the management server 105, the funeral home server 110, and/or the other servers 120. The blocks 237 of the distributed ledger 230 may be shared and synchronized across multiple sites and/or servers. Each site and/or server may independently maintain a distributed ledger 230 with multiple blocks 237.

Each block 237 may record a plurality of distributed ledger transactions 235. The distributed ledger transactions 235 may be hashed. In one embodiment, the hashed distributed ledger transactions 235 for each block 237 are compared and the block 237 is only recorded to the distributed ledger 230 if there is consensus for each block 237.

In one embodiment, a proof of work 231 is calculated for each block 237. The proof of work 231 may be calculated to have a cryptographic feature that is difficult to calculate but easy to verify. In one embodiment, the proof of work 231 incorporates previous blocks 233. The proof of work 231 may be used to validate the self-consistency of each block 237 of the distributed ledger 230.

FIG. 2F is a schematic block diagram illustrating one embodiment of system data 250. The system data 250 may be organized as a data structure in a memory. The system data 250 may include a display filter 251, a priority threshold 255, an effort threshold 259, and client information 273. The display filter 251 may determine which actionable entries 200 are presented as will be described hereafter. The priority threshold 255 may determine which actionable entries 200 are displayed in a limited set of actionable entries 200 as will be described hereafter. The effort threshold 259 may also be used to determine which actionable entries 200 are displayed in the limited set of actionable entries 200.

The client information 273 may store a collection of public and private information gathered through automated interviews and searches for information on the client. The client information 273 may be parsed to generate the client profile 271.

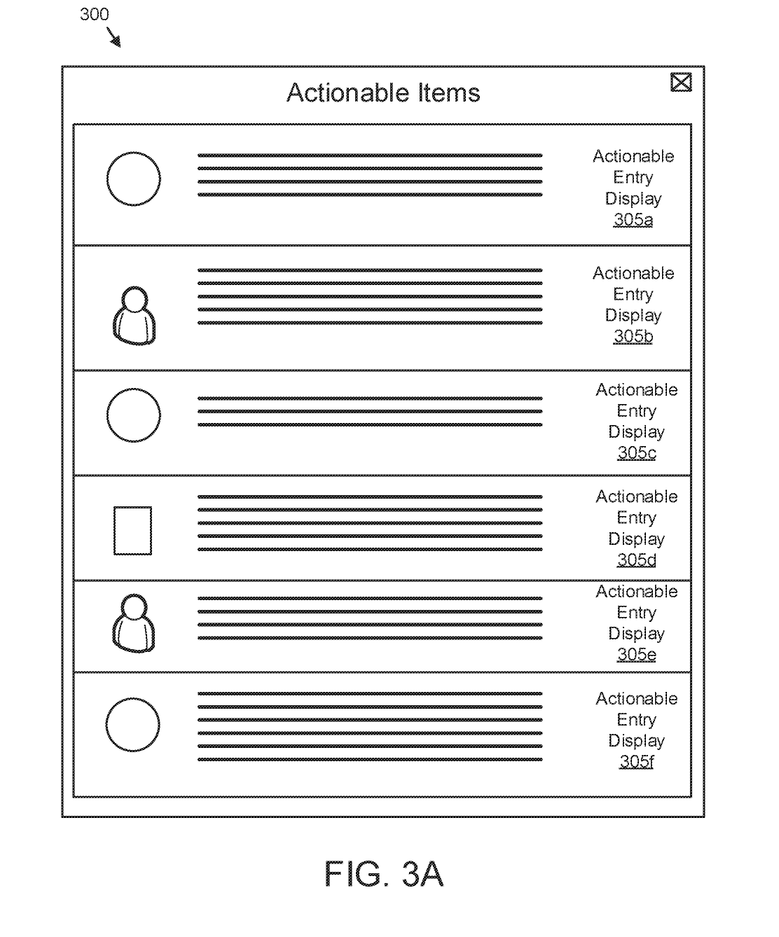

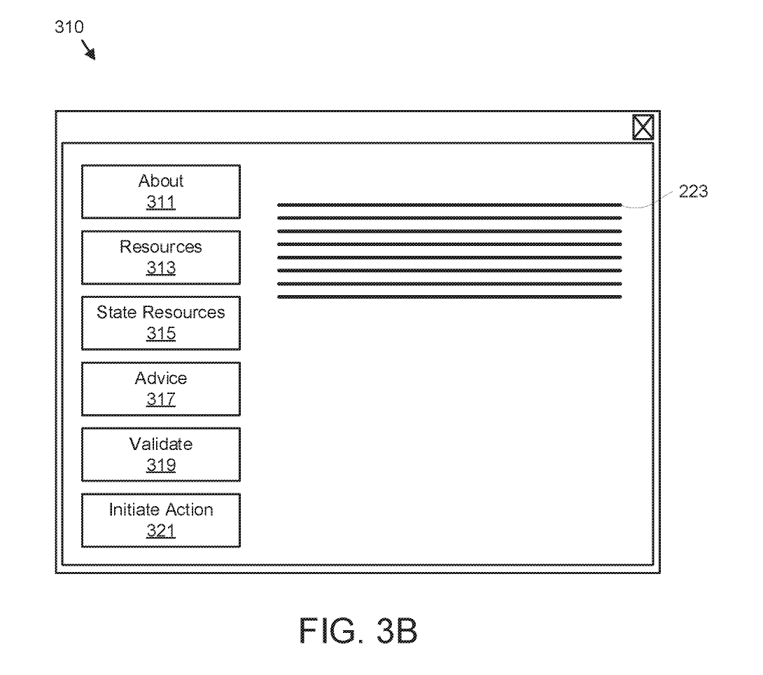

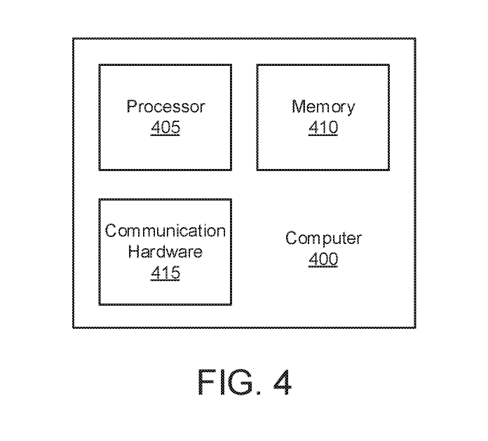

FIG. 3A is a drawing illustrating one embodiment of a display 300 of a limited set of actionable entry displays 305. The actionable entry displays 305 may be presented on a screen or the like. Each actionable entry display 305 may correspond to an actionable entry 200. The actionable entry displays 305 may describe actions 225 that should be performed on behalf of the client.

In one embodiment, the actionable entry displays 305 are limited based on the display filter 251. For example, the display filter 251 may only present actionable entry displays 305 for the most urgent actionable entries 200 with action priorities 253 that exceed the priority threshold 255. As a result, the user is only presented with the actionable entry displays 305 for the most urgent actionable entries 200.

In addition, the actionable entry displays 305 may be limited such that the sum of the action efforts 257 for each actionable entry 200 is less than the effort threshold 259. As a result, the user is not overwhelmed with actionable entry displays 305 that cannot be completed in a reasonable amount of time.

Selecting an actionable entry display 305 may launch the corresponding actionable entry 200. In one embodiment, an actionable entry 200 is launched in response to an automatic verification of a distributed ledger transaction.

FIG. 3B is a drawing illustrating one embodiment of action information 310. The action information 310 may be displayed on a screen for a launched actionable entry 200. The action information 310 may be associated with an action 225 of an actionable entry 200. In the depicted embodiment, the action information 310 includes an about button 311, a resources button 313, a state resources button 315, an advice button 317, a validate button 319, an initiate action button 321, and instructions 323. The action information 310 may enable the user to determine a course of action 225 and initiate that action 225.

When selected, the about button 311 may provide background information regarding the action 225. When selected, the resources button 313 may provide the user with information about private sector resources that may be used to perform the action 225. When selected, the state resources button 315 may provide the user with information about government resources that may be used to perform the action 225. When selected, the advice button 317 may provide the user with advice on performing the action 225.

In one embodiment, the validate button 319 validates that the action 225 was performed. For example, selecting the validate button 319 may retrieve a confirming email. In addition, selecting the validate button 319 may validate a block 237 recording a transaction 235 that completed the action 225.

In one embodiment, the validate button 319 validates the credentials of a party with which the action 225 is transacted. For example, the validate button 319 may validate a business license for a funeral home.

The initiate action button 321 may initiate the action 225. In one embodiment, initiating the action 225 automatically completes the action 225. Alternatively, selecting the initiate action button 321 may present the user with a series of prompts for completing the action 225. The instructions 223 may describe the use of the one or more buttons 311/313/315/317/319/321.

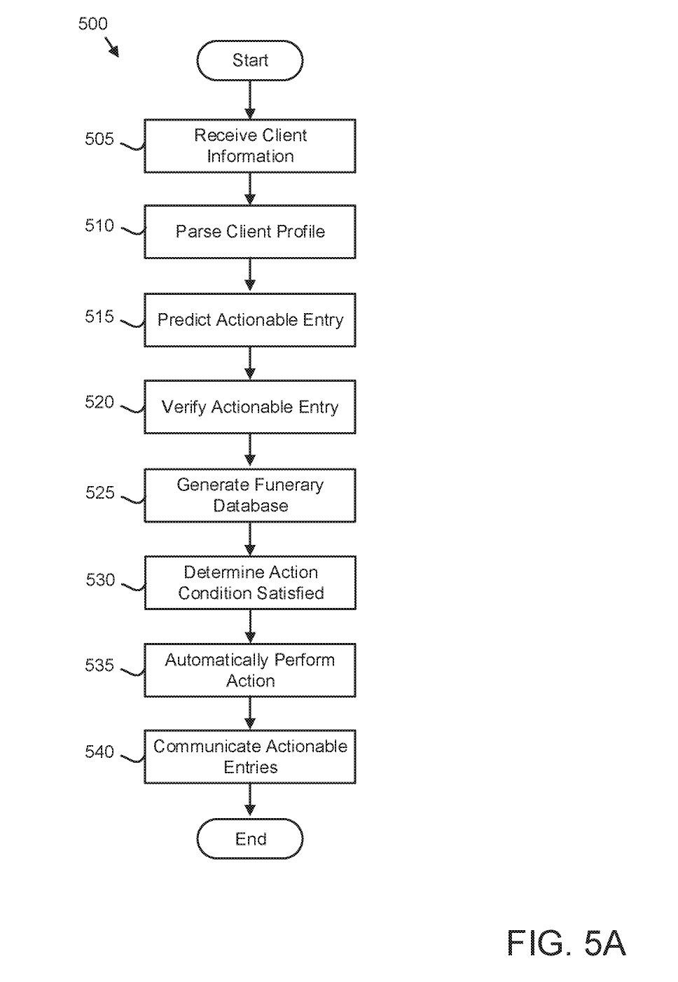

FIG. 4 is a schematic block diagram illustrating one embodiment of a computer 400. The computer 400 may be embodied in one or more of the management server 105, the funeral home server 110, the other servers 120, and the electronic device 125. In the depicted embodiment, the computer 400 includes a processor 405, a memory 410, and communication hardware 415. The memory 410 may include a semiconductor storage device, hard disk drive, an optical storage device, a micromechanical storage device, or combinations thereof. The memory 410 may store code. The processor 405 may execute the code. The communication hardware 415 may communicate with other devices. For example, the communication hardware 415 of the management server 105 may communicate through the network 115 with the communication hardware 415 of the funeral home server 110.

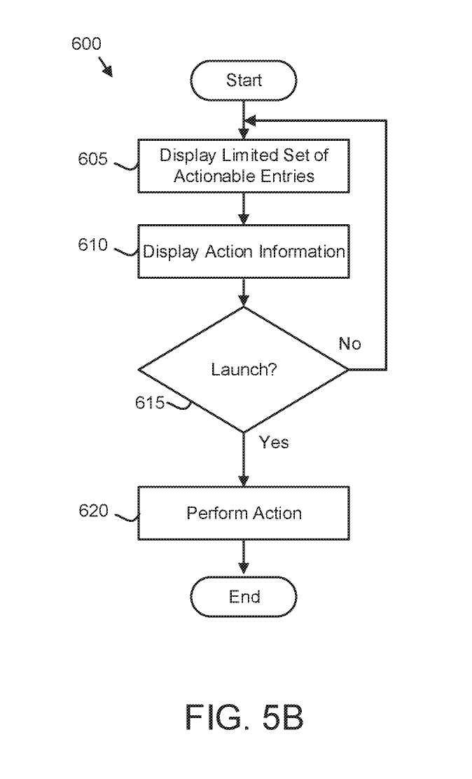

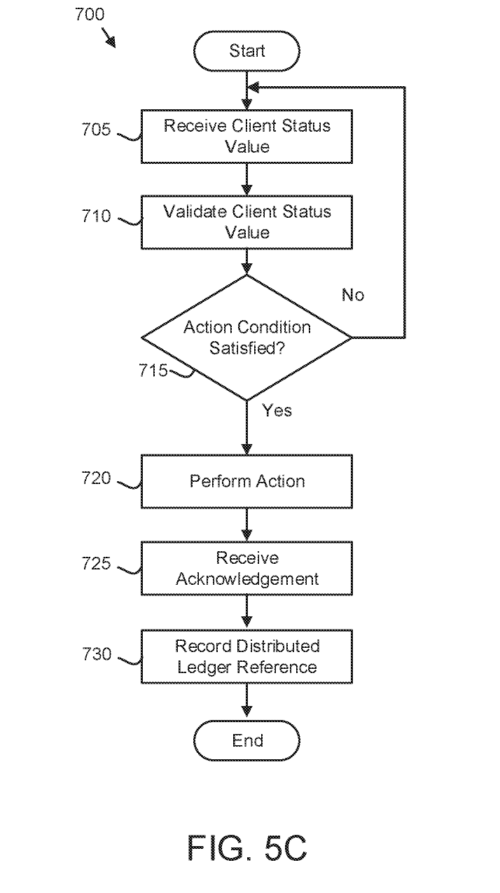

FIG. 5A is a schematic flow chart diagram illustrating one embodiment of an automatic action method 500. The method 500 may generate a funerary database 260 of actionable entries 200 for a client and automatically perform the actions 225 of the actionable entries 200 if it is determined that the client is deceased status 228 or impaired status 226. The method 500 may be performed by the computer 400, the processor 405, and/or the system 100.

The method 500 starts, and in one embodiment, the processor 405 receives 505 client information 273 for the client. The client and/or representative of the client may be interviewed using the electronic device 125. The client and/or representative the client may respond to questions and/or fill out data fields on the electronic device 125 to generate the client information 273. The processor 405 may further perform searches for the client information 273. The client information 273 may be stored on the management server 105 in a structured format, an unstructured format, or the like.

The processor 405 may parse 510 a client profile 271 from the client information 273. In one embodiment, the processor 405 augments the client profile 271 with additional information that is generated based on the client information 273.

In one embodiment, the processor 405 predicts 515 at least one actionable entry 200 from the client profile 271. The processor 405 may employ a process flow, a neural network, and/or table that use the client profile 271 as inputs to predict 515 the at least one actionable entry 200. For example, the processor 405 may predict 515 that the client is a veteran from the client profile 271. In addition, the processor 405 may predict 515 that the client was honorably discharged from the military service based on the client profile 271.

The processor 405 may verify 520 the at least one actionable entry 200. For example, the processor 405 may contact the other server 120 of the Veterans Administration to confirm that the client was honorably discharged from military service to verify 520 the actionable entry 200.

The processor 405 may generate 525 the funerary database 260. The funerary database 260 may comprise a plurality of actionable entries 200 for the client in a client entry 220.

The processor 405 may determine 530 that the action condition 219 is satisfied. The action condition 219 may be satisfied if the client is deceased status 228 or impaired status 226. In one embodiment, the processor 405 receives a notification from an administrator. The notification may be distributed ledger transaction 235. In addition, the processor 405 may parse one or more of published obituaries, a corners report, hospital admission reports, court documents, and the like to determine that the client is deceased or impaired. The determination 530 that the client is deceased status 228 or impaired status 226 is described in more detail in FIG. 5C.

In addition, the action condition 219 may be satisfied if information is needed for the client entry 220. For example, if the client's bank is uncertain, the action condition 219 may be satisfied.

In response to determining that 530 that the action condition 219 is satisfied, the processor 405 may automatically perform 535 the action 225 for one or more actionable entry 200 in the funerary database 260 in response to the client status value 223 for the actionable entry 200 satisfying the action condition 219 for the actionable entry 200. Performing 535 the action 225 is described in more detail in FIGS. 5B-C.

In one embodiment, the action 225 comprises one of sending a message to a Veterans Administration burial address and establishing direct communications with a Veterans Administration server 120 as specified in the veteran status entry 201. The action 225 may be performed using a distributed ledger transaction 235.

In addition, the action 225 may comprise sending a message to a Veterans Administration benefits address and establishing direct communications with a Veterans Administration benefits server 120 as specified in the retired military entry 203. The action 225 may be performed using a distributed ledger transaction 235.

The action 225 may further comprise sending a message comprising a link to organ donor instructions to a personal representative address and a funeral service provider address and establishing direct communications with an organ donor server 120 using the public ledger validation as specified in the organ donor entry 205.

In addition, the action 225 may comprise sending a message with safe deposit information to a personal representative address as specified in the safe deposit box entry 207. The action 225 may be performed using a distributed ledger transaction 235.

In one embodiment, the action 225 includes sending a message comprising the will information to a personal representative address as specified in the will entry 209. The action 225 may be performed using a distributed ledger transaction 235.

The action 225 may further include sending a message comprising the advance directive to a personal representative address and a care giver address as specified in the advanced directive entry 211. The action 225 may be performed using a distributed ledger transaction 235.

The action 225 may include sending a message with pet care information to a personal representative address as specified in the pet entry 213. In one embodiment, the action 225 includes sending a message comprising account access information to the personal representative address as specified in the personal representative entry 215.

In addition, the action 225 may comprise displaying the limited set of actionable entry displays 305 to gather more information for the client entry 220. As a result, additional information is acquired for the client entry 220.

In one embodiment, the processor 405 communicates 540 the actionable entry 200 to a funeral services provider and the method 500 ends. The actionable entry 200 may be communicated 540 to the funeral home server 110. The actionable entry 200 may be communicated 540 as an email communication. In addition, the actionable entry 200 may be communicated 540 as a distributed ledger transaction 235.

FIG. 5B is a schematic flow chart diagram illustrating one embodiment of an actionable entry display method 600. The method 600 may display a limited set of actionable entry displays 305 for actionable entries 200 as an automatic action 225 of step 535 of FIG. 5A. In addition, the method 600 may display the action information 310 for a launched actionable entry 200. The method 600 may be performed to create the client entry 220. In addition, the method 600 may be performed in response to satisfying an action condition 219. The method 600 may be performed by the computer 400, the processor 405, and/or the system 100.

The method 600 starts, and in one embodiment, the processor 405 displays 605 a limited set of actionable entries 220. The limited set of actionable entries 220 may each be displayed 605 as actionable entry displays 305. The actionable entry displays 305 may be displayed 605 to create the client entry 220. In addition, the actionable entry displays 305 may be displayed 605 in response to an action condition 219 being satisfied. In one embodiment, the action condition 219 is one of that the client is impaired status 226 and that the client is deceased status 228.

In one embodiment, an actionable entry display 305 is displayed 605 in response to the action priority 253 for the corresponding actionable entry 200 exceeding the priority threshold 255. In addition, the actionable entry display 305 may be displayed 605 in response to the action effort 257 for the corresponding actionable entry 200 exceeding the effort threshold 259.

The processor 405 may display 610 the action information 310 as shown in FIG. 3B. The action information 310 may be displayed 610 in response to a user selection launching the corresponding actionable entry 200. In addition, the action information 310 may be displayed 610 in response to the action priority 253 for the corresponding actionable entry 200 exceeding the priority threshold 255. In one embodiment, the action information 610 is displayed in response to an automatic verification of a distributed ledger transaction 235 for an actionable entry 200.

The processor 405 may determine 615 to launch an action 225 for an actionable entry 220. In one embodiment, the processor 405 determines 615 to launch the action 225 in response to at least one of a user selection and an automatic verification of a distributed ledger transaction 235 for the corresponding actionable entry 200. In addition, the processor 410 may determine 615 to launch the action 225 in response to the action priority 253 for the corresponding actionable entry 200 exceeding the priority threshold 255. For example, the priority threshold 255 may indicate all actions 225 that should be completed immediately.

If the processor 405 determines 615 not to launch the action 225, the processor 405 continues to display 605 the limited set of actionable entry displays 305. If the processor 405 determines 610 to launch the action 225, the processor 405 performs 620 the action 225 and the method 600 ends. The action 225 may be performed 620 as described in step 535 of FIG. 5A.

FIG. 5C is a schematic flow chart diagram illustrating one embodiment of an action performance method 700. The method 700 may perform the action 225 of an actionable entry 200. In one embodiment, the method 700 performs step 535 of FIG. 5A. The method 700 may be performed by the computer 400, the processor 405, and/or the system 100.

The method 700 starts, and in one embodiment, the processor 405 receives 705 the client status value 223. The client status 223 value may be the impaired status 226 or the deceased status 228. The client status value 223 may be received as a distributed ledger transaction 235. In addition, the client status value 223 may include that client information for an actionable entry 200 is missing. For example, the client status value 223 for an emergency contact may be False.

In one embodiment, the processor 405 validates 710 the client status value 223. The client status value 223 may be validated 710 by confirming the source of the client status value 223. In addition, the client status value 223 may be validated 710 with the distributed ledger transaction 223.

The processor 405 may determine 715 if the action condition 219 is satisfied by the client status value 223. If the action condition 219 is not satisfied, the processor 405 continues to receive client status values 223. The action condition 219 may be satisfied for one of the impaired status 226 or the deceased status 228. In addition, the action condition 219 may be satisfied for missing information, such as the emergency contact client status value 223 being False.

If the action condition 219 is satisfied by the client status value 223, the processor 405 may perform 720 the action 225. The action 225 may be performed 720 by communicating a message. In addition, the action 225 may be performed 720 as a distributed ledger transaction 235. In one embodiment, the action 225 is performed 720 by requesting information from a user such as by displaying the limited set of actionable entry displays as shown in FIG. 3A.

The processor 405 may further receive 725 an acknowledgment that the action 225 is performed. The acknowledgment may be an email response. In addition, the acknowledgment may be a distributed ledger transaction 235. The processor 405 may record 730 the distributed ledger transaction 235 to the distributed ledger reference 229 and the method 700 ends.

The embodiments generate a funerary database 260 with actionable entries 200 for a client. A limited set of the actionable entries 200 may be displayed as actionable entry displays 305 to allow a user to initiate an action 225 to care for the client and/or carry out the client's last wishes. The actionable entries 200 are limited so as not to overwhelm the user during what is likely a very stressful time. In addition, the actionable entries 200 are limited to those actionable entries 200 with the highest action priority 253. As a result, the embodiments encourage the performance of the most important actions 225 in a timely manner.

The embodiments further determine a client status value 223 and in response to the client status value 223 satisfying the action condition 219, automatically perform the action 225 for the actionable entry 200. The client status value 223 may be validated so that the action 225 is not performed prematurely. In addition, the action 225 may be validated to ensure the timely performance of the action 225. As a result, the embodiments improve the efficiency of the computer 400 performing the funerary requests of the client as the actions are automatically performed.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
generating, by use of a processor, a funerary database comprising a plurality of actionable entries for a client, wherein each actionable entry comprises an action condition, a client status description, a client status value, and an action; and
in response to the client status value satisfying the action condition, automatically performing the action for the actionable entry.

2. The method of claim 1, wherein the action condition is that the client is one of deceased and impaired.

3. The method of claim 1, the method further comprising:
receiving client information for the client in response to interview data;
parsing a client profile from the client information;
predicting a first actionable entry from the client profile; and
verifying the first actionable entry.

4. The method of claim 1, the method further comprising:
displaying a limited set of actionable entries for the client, wherein each of the limited set of actionable entries is in an unlaunched state; and
displaying first action information for a first actionable entry of the limited set of actionable entries.

5. The method of claim 4, wherein the first actionable entry is launched in response to at least one of a user selection and an automatic verification of a distributed ledger transaction and the first action information is displayed for the launched first actionable entry.

6. The method of claim 1, the method further communicating the actionable entries to a funeral services provider.

7. The method of claim 1, the method further validating the client status value with a distributed ledger transaction.

8. The method of claim 1, wherein the plurality of actionable entries comprises a veteran status entry with a client status description that indicates an honorable discharge from military service, wherein the action of the veteran status entry comprises one of sending a message to a Veterans Administration burial address and establishing direct communications with a Veterans Administration server.

9. The method of claim 1, wherein the plurality of actionable entries comprises a retired military entry with a client status description that indicates the client retired from military service, wherein the action of the retired military entry comprises sending a message to a Veterans Administration benefits address and establishing direct communications with a Veterans Administration benefits server.

10. The method of claim 1, wherein the plurality of actionable entries comprises an organ donor entry with a client status description that indicates the client is an organ donor, wherein the action of the organ donor entry comprises sending a message comprising a link to organ donor instructions to a personal representative address and a funeral service provider address and establishing direct communications with an organ donor server using the public ledger validation.

11. The method of claim 1, wherein the plurality of entries comprises a safe deposit box entry with a client status description that indicates the client has a safe deposit box, wherein the action of the safe deposit box entry comprises sending a message with safe deposit information to a personal representative address.

12. The method of claim 1, wherein the plurality of entries comprises a will entry with a client status description that indicates the client has a will, wherein the action of the will entry comprises sending a message comprising will information to a personal representative address.

13. The method of claim 1, wherein the plurality of entries comprises an advance directive entry with a client status description that indicates the client has an advance directive, wherein the action of the advance directive entry comprises sending a message comprising the advance directive to a personal representative address and a care giver address.

14. The method of claim 1, wherein the plurality of entries comprises a pet entry with a client status description that indicates the client cares for a pet, wherein the action of the pet entry comprises sending a message with pet care information to a personal representative address.

15. The method of claim 1, wherein the plurality of entries comprises a personal representative entry with a client status description that indicates the client has a personal representative, wherein the action of the personal representative entry comprises sending a message comprising account access information to a personal representative address.

16. An apparatus comprising:
a processor;
a memory storing code executable by the processor to perform:
generating a funerary database comprising a plurality of actionable entries for a client, wherein each actionable entry comprises an action condition, a client status description, a client status value, and an action; and
in response to the client status value satisfying the action condition, automatically performing the action for the actionable entry.

17. The apparatus of claim 16, the processor further:
receiving client information for the client in response to interview data;
parsing a client profile from the client information;
predicting a first actionable entry from the client profile; and
verifying the first actionable entry.

18. The apparatus of claim 16 of claim 1, the processor further:
displaying a limited set of actionable entries for the client, wherein each of the limited set of actionable entries is in an unlaunched state; and
displaying first action information for a first actionable entry of the limited set of actionable entries.

19. A program product comprising a non-transitory computer readable storage medium that stores code executable by a processor to perform:
generating a funerary database comprising a plurality of actionable entries for a client, wherein each actionable entry comprises an action condition, a client status description, a client status value, and an action; and
in response to the client status value satisfying the action condition, automatically performing the action for the actionable entry.

20. The program product of claim 19, the processor further:
receiving client information for the client in response to interview data;
parsing a client profile from the client information;
predicting a first actionable entry from the client profile; and
verifying the first actionable entry.
